(19) United States
(12) Patent Application Publication
(10) Pub. No.: US 2008/0168026 A1
(43) Pub. Date: Jul. 10, 2008

(54) Intelligent Method for Resolving Ambiguity in Identical Addresses in Email

(76) Inventors: Sandeep Ramesh Patil, Pune (IN); Ranadip Das, West Bengal (IN); Venkat Venkatsubra, Austin, TX (US); Dwip N. Banerjee, Austin, TX (US)

Correspondence Address: HAMILTON & TERRILE, LLP;IBM Austin, P.O. BOX 203518, AUSTIN, TX, 78720, US

(21) Appl. No.: 11/621,323

(22) Filed: Jan. 9, 2007

(51) Int. Cl. G06F 17/30; G06F 15/16

(52) U.S. Cl. 707/2; 709/206; 707/E17.124

(57) ABSTRACT

An email content management method, system and program are provided for mapping subsets of electronic mail (email) message content sent to one or more recipients with the same or similar names. Subsets of email message content are accentuated and designated for a predetermined recipient. Coordinates of the accentuated content are automatically generated and stored in a message recipient mapping table with display attributes and the email ID of the designated recipient. The recipient's email client receives the email, and if the recipient's email ID is present in the recipient mapping table, corresponding message content coordinates are retrieved and their associated display attributes are applied. The entirety of the email message content is displayed with subsets of the message content designated for the recipient accentuated according to their respective display attributes.

### BACKGROUND OF THE INVENTION

1. Field of the Invention

The present invention relates in general to computer software and more particularly, to resolving recipient name ambiguity in email message content.

2. Description of the Related Art

Electronic mail (email) has become a fast, reliable, and easy-to-use method of communication and as such, it has become an important tool for conducting business. While email for commercial purposes can be highly effective, its growing popularity has led to a corresponding increase in the number of email accounts. A unique email address is generated for each of these accounts, which are often assigned aliases to facilitate their recognition, tracking and management. It is also common for other information, such as physical mailing addresses, to be associated with these accounts. As a result, numerous email address books, directories and databases have been developed and implemented.

However, identity management has become an issue as the number of email recipients has grown because inevitably, some email account holders share the same name. For example, it is not uncommon for even a small organization to have employees with the same first and last name (e.g., Bob C. Smith, Bob W. Smith, etc.). Even more common is to have employees with different last names, but sharing the same first name (e.g., Bob Smith, Bob Jones, etc.). Addressing an email to multiple recipients that share these name similarities generally poses no problem, especially with email clients that provide an integrated address book for their respective Email ID. For example, it is not unusual for a manager to compose an email containing a list of individual assignments and sending it to a group of employees. While such an email allows the employees to be aware of all assignments, which employee is responsible for which assignment can become ambiguous and confusing if two or more recipients have the same or similar names. To reduce or eliminate this ambiguity, the sender of the email has to be diligent in clarifying which assignment in the email is assigned to which recipient, which can be tedious, error-prone and time consuming. Furthermore, each recipient of the email must then carefully determine which assignment is theirs, which can be equally challenging.

Prior approaches to email recipient identity management have included treating Email ID as objects, which facilitates their addition, deletion, modification and iconization. Other approaches have included the implementation of junk email filtering techniques, but these simply reduce the number of misdirected emails. Still others assign a priority to the incoming email, either through the application of an icon, color coding, or by filing the email in a predetermined mailbox. Another prioritization approach is to send a group email to individual recipients, with each recipient's portion(s) of the email receiving a different priority (e.g., priority, pending assignment, information only, etc.). Alternatively, some workflow and project management solutions are capable of marking individual task assignments within an email and then tracking the assignment and its assignee (i.e., the recipient) in a database. All of these address different aspects of email recipient management, yet none of them facilitate the differentiation of similar addressee names to reduce identity ambiguity.

### SUMMARY

Email content management is provided for mapping subsets of electronic mail (email) message content sent to one or more recipients with the same or similar names. In selected embodiments of the invention, email identifiers (IDs) of recipients, some of which may have the same or similar names, are entered into an email client by the sender. Subsets of email message content are accentuated through user gesture, such as using a mouse in a click and drag operation. The accentuated content is then designated through similar user gestures to a predetermined recipient chosen from the previously entered email IDs.

The coordinates of the accentuated content are then automatically generated and stored in a message recipient mapping table along with display attributes and the corresponding email ID of the designated recipient. Once all email message content is accentuated and respectively designated for a predetermined recipient, the email recipient mapping table is updated and appended to the email file, which is then sent. The email recipient's email client receives the email and examines it for the presence of a recipient mapping table. If found, the email client parses the recipient mapping table and searches for instances of the user's email ID and aliases. Instances of the recipient's email ID and aliases are identified, the corresponding message content coordinates retrieved, and the associated display attributes are applied to the email message content. The entirety of the email message content is then displayed for the recipient, with subsets of the message content designated for the recipient accentuated according to their respective display attributes.

In one embodiment, a message digest of the email message content and the associated email recipient mapping table is generated and then encrypted using the sender's private key to generate a digital signature. In another embodiment, the email message content, the associated email recipient mapping table, the message digest, and the sender's digital signature is encrypted by the sender and decrypted by the recipient using public/private key cryptographic operations. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a flow chart for mapping accentuated subsets of unsent email message content to predetermined recipients;

FIG. 3 shows a flow chart for displaying accentuated subsets of received email message content mapped to predetermined recipients;

FIG. 4 shows a flow chart for using digital signatures to validate the authenticity of unsent email message content subsets that have been accentuated and mapped to predetermined recipients;

FIG. 5 shows a flow chart for displaying accentuated subsets of digitally-signed, received email message content that is received and mapped to predetermined recipients;

FIG. 6 shows a message recipient mapping table as implemented in an email file format;

FIG. 7 shows the user interface of an email client used for mapping accentuated subsets of unsent email message content to predetermined recipients, and;

FIG. 8 shows the user interface of an email client used for viewing an accentuated subset of received email message content mapped to a predetermined recipient.

### DETAILED DESCRIPTION

An email content management method, system and program are disclosed for mapping subsets of electronic mail (email) message content sent to one or more recipients with the same or similar names. Email IDs of recipients, some of which may have the same or similar names, are entered into an email client by the sender. Subsets of email message content are accentuated through user gesture, such as using a mouse in a click and drag operation. The accentuated content is then designated through similar user gestures to a predetermined recipient chosen from the previously entered email IDs. The coordinates of the accentuated content are then automatically generated and stored in a message recipient mapping table along with display attributes and the corresponding email ID of the designated recipient. Once all email message content is accentuated and respectively designated for a predetermined recipient, the email recipient mapping table is updated and appended to the email file, which is then sent. The recipient's email client receives the email and examines it for the presence of a recipient mapping table. If found, the email client parses the recipient mapping table and searches for instances of the user's email ID and aliases. Instances of the recipient's email ID and aliases are identified, the corresponding message content coordinates retrieved, and the associated display attributes are applied to the email message content. The entirety of the email message content is then displayed for the recipient, with subsets of the message content designated for the recipient accentuated according to their respective display attributes.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

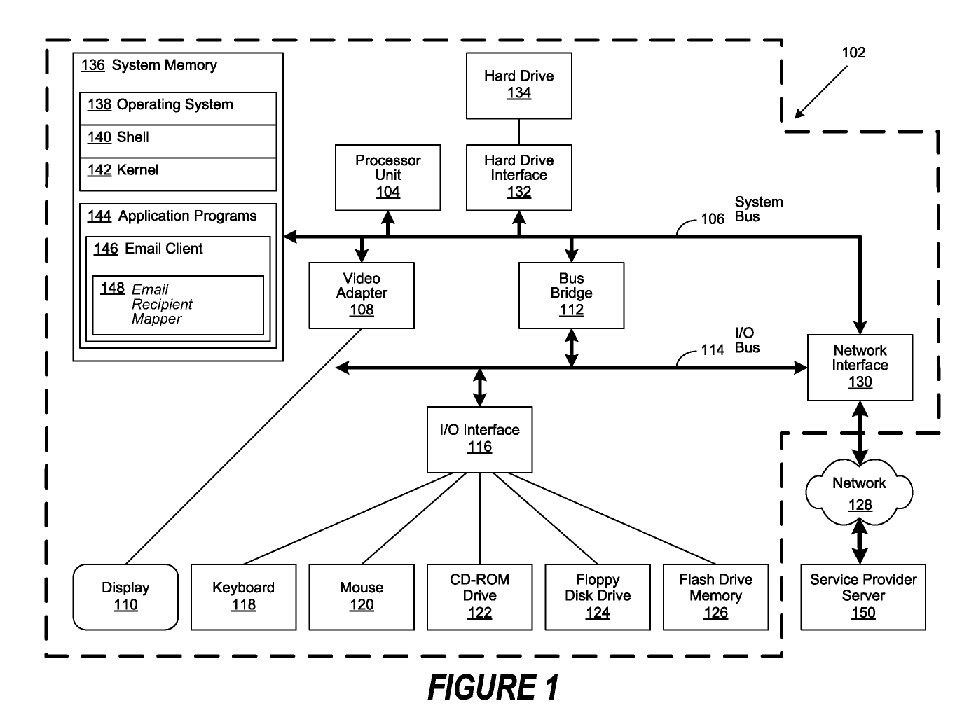

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

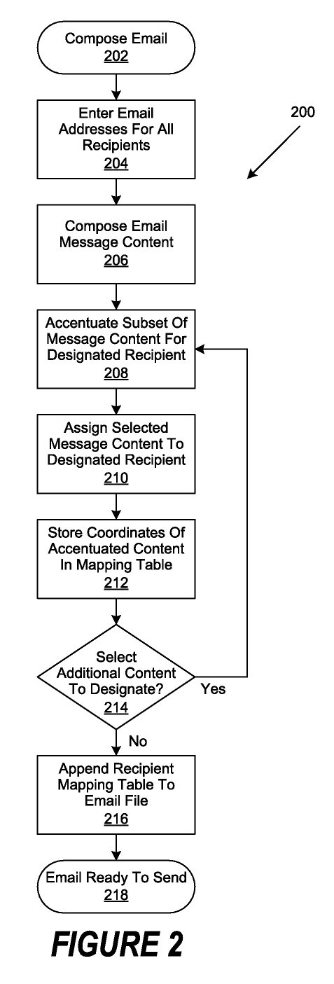

Application programs 144 may include an email client 146. Email client 146 includes program modules and instructions enabling email messages to be sent and received. Email client 146 also includes an email recipient mapper 148. Email mapper 148 includes code for implementing the processes described in FIGS. 2-8 described hereinbelow. In one embodiment, client computer 102 is able to download email recipient mapper 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a flow chart for mapping accentuated subsets of unsent email message content 200 to predetermined recipients. In selected embodiments of the invention, an email sender begins composition of an email in step 202. Email IDs of recipients, some of which may have the same or similar names, are entered into the email client in step 204 and email message content is composed in step 206. It will be appreciated that it is not uncommon for even a small organization to have employees with the same first and last name (e.g., Bob C. Smith, Bob W. Smith, etc.). Even more common is to have employees with different last names, but sharing the same first name (e.g., Bob Smith, Bob Jones, etc.).

Composing and addressing an email to multiple recipients that share these name similarities can create ambiguity and confusion, particularly when the sender has not been diligent in clarifying which content in the email is intended for which recipient. In the course of composing the email, the sender mitigates this issue in step 208 by accentuating message content to be designated for one or more predetermined recipients. In one embodiment, message content is accentuated through user gesture, such as using a mouse in a click and drag operation to accentuate the selection, which can be displayed as an outlined area within the sender's email client interface. In another embodiment, message content is accentuated in color, with the user having the option to select a different accentuation color for each designated recipient. The accentuated content is then designated through similar user gestures to a predetermined recipient chosen from the previously entered email recipients in step 210. In one embodiment, a drop-down content attributes window is opened within the email client interface and the sender chooses an assignment option.

Once chosen, a list of the email recipients previously entered in the “To:” field of the email is presented and the sender chooses one or more recipients as designees for the accentuated content. The coordinates of the accentuated content are then automatically generated and stored in a message recipient mapping table, described in greater detail herein, along with the corresponding email ID of the designated recipient in step 212. In one embodiment, the area comprising the accentuated content is referenced by column and line number coordinates. In another embodiment, the area comprising the accentuated content is referenced by x-y positional coordinates measured in pixels or other metrics. If it is determined in step 214 that additional email message content is to be accentuated and designated for a predetermined recipient, the process is repeated beginning in step 208. Once all email message content is accentuated and respectively designated for a predetermined recipient, the email recipient mapping table is updated and appended to the email file in step 216. In one embodiment, the email recipient mapping table is stored in a hidden area of the email file and is not viewable. The email is then ready to send in step 218.

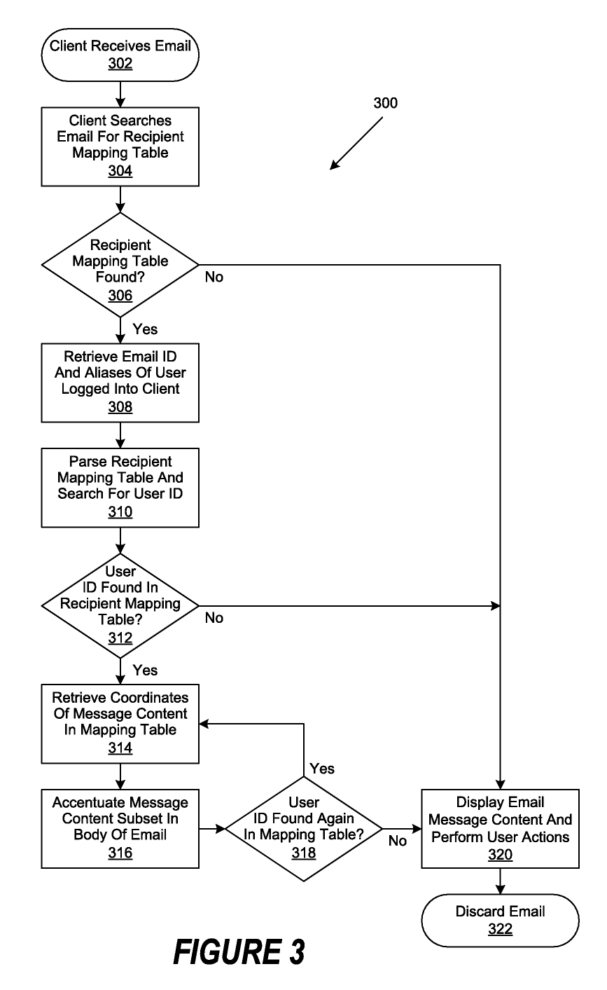

FIG. 3 shows a flow chart for displaying accentuated subsets of received email message content 300 mapped to predetermined recipients. In selected embodiments of the invention, an email recipient logs into an email client to receive email beginning in step 302. The user's email client examines the incoming email for the presence of a recipient mapping table in step 304. If it is determined in step 306 that a recipient mapping table is not appended to the incoming email, then the message content of the email is displayed in step 320 for the recipient to perform user actions. After all user actions are concluded, the email can be discarded in step 322. If it is determined in step 306 that a recipient mapping table is appended to the incoming email, the email client retrieves the email ID and associated aliases of the logged-in user in step 308. The recipient mapping table is then parsed and searched for instances of the user's email ID and aliases in step 310.

If it is determined in step 312 that the user's email ID and aliases are not present in the recipient mapping table, then the message content of the email is displayed in step 320 for the recipient to perform user actions. After all user actions are concluded, the email can be discarded in step 322. If it is determined in step 312 that the user's email ID and aliases are present in the recipient mapping table, the first instance of the email ID and aliases are identified and the corresponding message content coordinates and display attributes are retrieved in step 314. The message content referenced by the coordinates is then accentuated in the user interface of the email client in step 316 according to the corresponding display attributes. For example, a display attribute of <Red, Bold> may indicate that the accentuated text content be displayed in a red, bold typeface, whereas <Yellow, Highlight> may indicate that the accentuated text content be highlighted with a yellow background behind a regular typeface. In one embodiment, the recipient's email client can be configured to override the display attributes with attributes of the recipient's choosing. It will be appreciated that many such display attribute variations are possible, extending to non-text content, such as embedded binary files for graphics such as tables, charts or drawings.

If it is determined in step 318 that other instances of the user's email ID and aliases are present in the recipient mapping table, then the process is repeated beginning with step 314. Once all instances of the user's email ID and aliases have been identified in the recipient mapping table and their corresponding message content coordinates retrieved and display attributes applied, the email message is displayed in step 320 for the recipient to perform user actions. After all user actions are concluded, the email can be discarded in step 322.

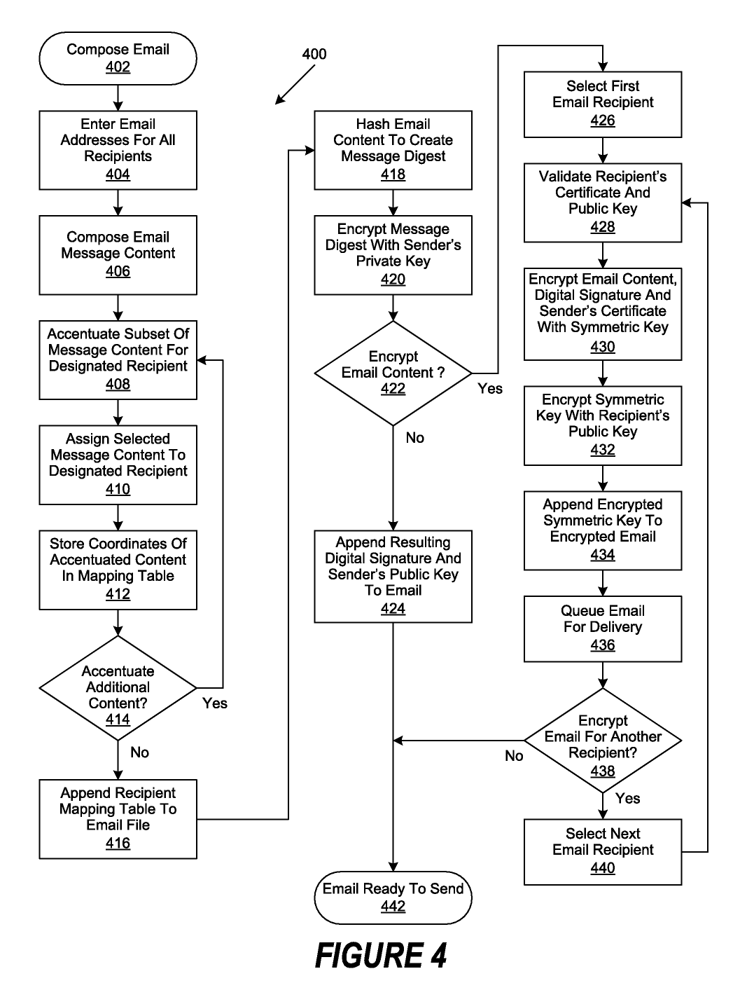

FIG. 4 shows a flow chart for using digital signatures to validate the authenticity of unsent email message content subsets that have been accentuated and mapped 400 to predetermined recipients. In selected embodiments of the invention, a public key infrastructure (PKI) is implemented to manage digital certificates validating the authenticity of email senders and recipients. In these embodiments, an email sender begins composition of an email in step 402. Email IDs of recipients, some of which may have the same or similar names, are entered into the email client in step 404 and email message content is composed in step 406.

Composing and addressing an email to multiple recipients that share the same or similar names can create ambiguity and confusion, particularly when the sender has not been diligent in clarifying which content in the email is intended for which recipient. In the course of composing the email, the sender mitigates this issue in step 408 by accentuating message content to be designated for one or more predetermined recipients. In one embodiment, message content is accentuated through user gesture, such as using a mouse in a click and drag operation to accentuate the selection, which can be displayed as an outlined area within the sender's email client interface. In another embodiment, selected text or other content is accentuated in color, with the user having the option to select a different accentuation color for each designated recipient. The accentuated content is then assigned through similar user gestures to a designated recipient chosen from the previously entered email recipients in step 410. In one embodiment, a drop-down content attributes window is opened within the email client interface and the sender chooses an assignment option. Once chosen, a list of the email recipients previously entered in the “To:” field of the email is presented and the sender chooses one or more recipients as designees for the accentuated content.

The coordinates of the accentuated content are then automatically generated and stored in a message recipient mapping table, described in greater detail herein, along with the corresponding email ID of the designated recipient in step 412. In one embodiment, the area comprising the accentuated content is referenced by column and line number coordinates. In another embodiment, the area comprising the accentuated content is referenced by x-y positional coordinates measured in pixels or other metrics. If it is determined in step 414 that additional email message content is to be accentuated and designated for a predetermined recipient, the process is repeated beginning in step 408. Once all email message content is accentuated and respectively designated for a predetermined recipient, the email recipient mapping table is updated and appended to the email file in step 416. In one embodiment, the email recipient mapping table is stored in a hidden area of the email file and is not viewable.

In step 418, a cryptographic hash function such (e.g., MD5 or SHA-1) is applied to the email message content, any binary file attachments, and the appended email recipient mapping table to produce a message digest. The message digest, which is fixed length string smaller than the message content itself, is then encrypted with the email sender's private key in step 420 to generate a digital signature. Those of skill in the art will recognize that while a digital signature provides the ability for a recipient to verify that the integrity of the message has been preserved, it does not provide encryption of the message itself.

If it is determined in step 422 that the email contents are not to be encrypted, then the resulting digital signature and the sender's public key are appended to the email in step 424 and the email is then ready to send in step 442. However, if it is determined in step 422 that the email contents are to be encrypted, then a first recipient of the email is chosen in step 426. In step 428, the first recipient's digital certificate is retrieved through the PKI and validated to authenticate the recipient's public key. Once the first recipient's digital certificate has been validated, the message content of the email, any binary attachments, the email recipient mapping table, and the sender's digital signature and digital certificate are then encrypted with a one-time, randomly-generated symmetric key in step 430. After encryption is completed, the one-time symmetric key is encrypted with the recipient's public key in step 432. The encrypted symmetric key is then appended to the email file in step 434 and the file is queued for delivery in step 436. If it is determined in step 438 that the message content of the email is to be encrypted for other recipients, then the next recipient is selected in step 440 and the process is repeated beginning with step 428. Otherwise, the encrypted email is then ready to send in step 442.

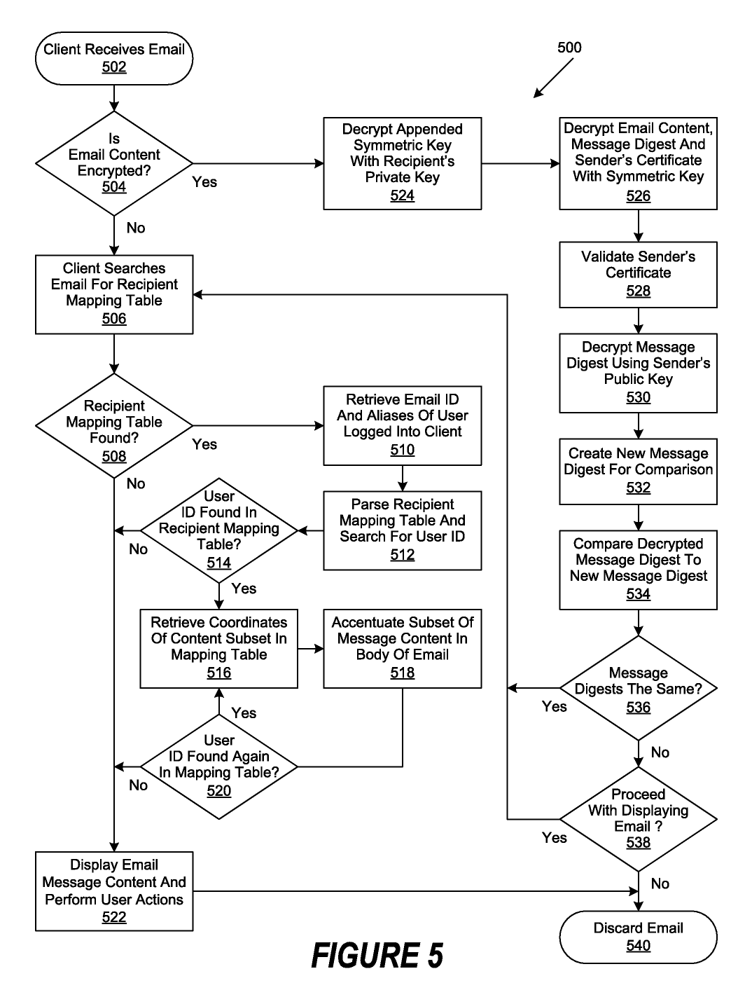

FIG. 5 shows a flow chart for displaying accentuated subsets of digitally-signed and encrypted email message content that is received and mapped 500 to predetermined recipients. In selected embodiments of the invention, a public key infrastructure (PKI) is implemented to manage digital certificates validating the authenticity of email senders and recipients. In these embodiments, an email recipient logs into an email client to receive email beginning in step 502. The user's email client examines the incoming email to determine in step 504 if the email's message content is encrypted. If it is, the encrypted symmetric key appended to the encrypted email message content is decrypted with the recipient's private key in step 524. Once decrypted, the retrieved private key is used in step 526 to decrypt the email's message content, any attached binary files, and the sender's digital signature and digital certificate.

The decrypted digital signature of the sender is then validated in step 528 to authenticate the sender's public key, which once authenticated, is used to decrypt the sender's digital signature and retrieve the original message digest of the email's message content in step 530. A new message digest is then generated in step 532 by applying the same cryptographic hash function (e.g., MD5 or SHA-1) to the decrypted email message content, any binary file attachments, and the appended email recipient mapping table. A comparison operation is then performed against the newly created message digest and the decrypted message digest in step 534. If it is determined in step 536 that the two message digests are not the same, then the integrity of the email message content has been compromised and a determination is made in step 538 whether to proceed with displaying the contents of the email. If it is determined in step 538 to not display the contents of the email, then the email can be discarded in step 540.

If it is determined in step 538 to proceed with displaying the contents or the email, or if it is determined in step 536 that the two message digests match each other, then the email client searches the decrypted email for the presence of a recipient mapping table in step 506. If it is determined in step 508 that a recipient mapping table is not appended to the incoming email, then the message content of the email is displayed in step 522 for the recipient to perform user actions. After all user actions are concluded, the email can be discarded in step 540. If it is determined in step 508 that a recipient mapping table is appended to the incoming email, the email client retrieves the email ID and associated aliases of the logged-in user in step 510. The recipient mapping table is then parsed and searched for instances of the user's email ID and aliases in step 512. If it is determined in step 514 that the user's email ID and aliases are not present in the recipient mapping table, then the message content of the email is displayed in step 522 for the recipient to perform user actions. After all user actions are concluded, the email can be discarded in step 540.

If it is determined in step 514 that the user's email ID and aliases are present in the recipient mapping table, the first instance of the email ID and aliases are identified and the corresponding message content coordinates and display attributes are retrieved in step 516. The message content referenced by the coordinates is then accentuated in the user interface of the email client in step 518 according to the corresponding display attributes. For example, a display attribute of <Red, Bold> may indicate that the accentuated text content be displayed in a red, bold typeface, whereas <Yellow, Highlight> may indicate that the accentuated text content be highlighted with a yellow background behind a regular typeface. In one embodiment, the recipient's email client can be configured to override the display attributes with attributes of the recipient's choosing. It will be appreciated that many such display attribute variations are possible, extending to non-text content, such as embedded binary files for graphics such as tables, charts or drawings.

If it is determined in step 520 that other instances of the user's email ID and aliases are present in the recipient mapping table, then the process is repeated beginning with step 516. Once all instances of the user's email ID and aliases have been identified in the recipient mapping table and their corresponding message content coordinates retrieved and display attributes applied, the email message is displayed in step 522 for the recipient to perform user actions. After all user actions are concluded, the email can be discarded in step 540.

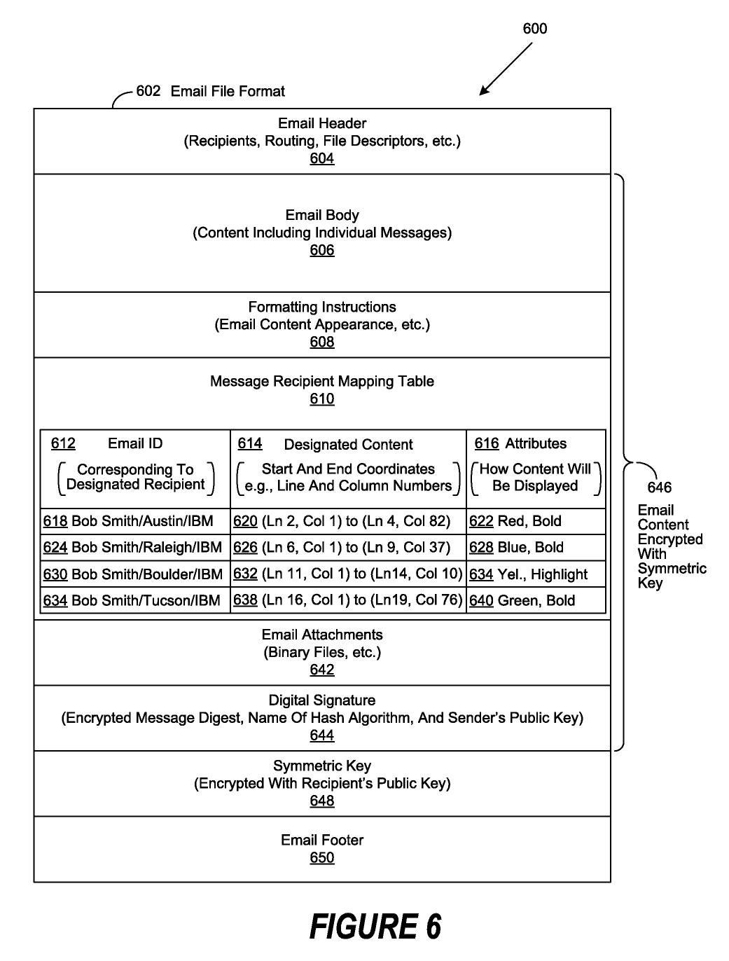

FIG. 6 shows a message recipient mapping table as implemented in an email file format 600. In selected embodiments of the invention, email file format comprises email header 604, email body 606, formatting instructions 608, message recipient mapping table 610, email attachments 642, digital signature 644, encrypted symmetric key 648, and email footer 650. The email header 604 typically comprises Email ID of the email recipients, file descriptors and other related information required to deliver and process the email for use by the recipient. The email body 606 typically comprises text, with embedded binary files such as pictures and charts attached as binary file attachments 642. The formatting instructions 608 typically comprise instructions processed by an email client for the presentation of message content comprising email body 606 and binary attachments 642.

Message recipient mapping table 610 comprises the email ID 612 of a designated recipient to receive predetermined subsets of email message content in email body 606, the start and end coordinates 614 of the content subset, and the content subset's display attributes 616. Email ID 612 comprises the designated recipient's email address, aliases, and other information required to uniquely identify a predetermined recipient. It will be appreciated that it is not uncommon for even a small organization to have employees with the same first and last name. For example, Email ID 612 in this figure comprises individual recipients Bob Smith/Austin/IBM 618, Bob Smith/Raleigh/IBM 624, Bob Smith/Boulder/IBM 630 and Bob Smith/Tucson/IBM 634. Even more common is to have employees with different last names, but sharing the same first name (e.g., Bob Smith, Bob Jones, etc.).

Composing and addressing an email to multiple recipients that share these name similarities can create ambiguity and confusion, particularly when the sender has not been diligent in clarifying which content in the email is intended for which recipient. This issue is mitigated in the course of composing an email by accentuating message content that is designated for one or more predetermined recipients. In one embodiment, message content is selected through user gesture, such as using a mouse in a click and drag operation to outline or accentuate the selection within the sender's email client interface.

The accentuated content is then assigned through similar user gestures to a designated recipient chosen from the previously entered email recipients. The coordinates (e.g., 620, 626, 632, 638) of the accentuated content 614 are then automatically generated and stored in the message recipient mapping table 610 corresponding to the respective email ID (e.g., 618, 624, 630, 634) of the designated recipient 612. In one embodiment, the area comprising the accentuated content is referenced by column and line number coordinates. In another embodiment, the area comprising the accentuated content is referenced by x-y positional coordinates measured in pixels or other metrics. In another embodiment, selected text or other content is accentuated in color, with the sender having the option to select a different accentuation color for each designated recipient. The selected color and other attributes (e.g., bold text, highlighted, etc.) related to how the accentuated content will be displayed to the recipient is stored as display attributes 622, 518, 634, 640 corresponding to their respective content coordinates 620, 626, 632, 638.

In selected embodiments, a message digest is generated of the email body 606, formatting instructions 608, message recipient mapping table 610, and email attachments 642. The hash is then encrypted with the sender's private key to generate a digital signature 644, which comprises the name of the hash algorithm implemented to generate the message digest as well as the sender's public key. In other embodiments, the email body 606, formatting instructions 608, message recipient mapping table 610, email attachments 642, and digital signature 644 are encrypted 646 with a one time symmetric key 648, which is subsequently encrypted with the recipient's public key.

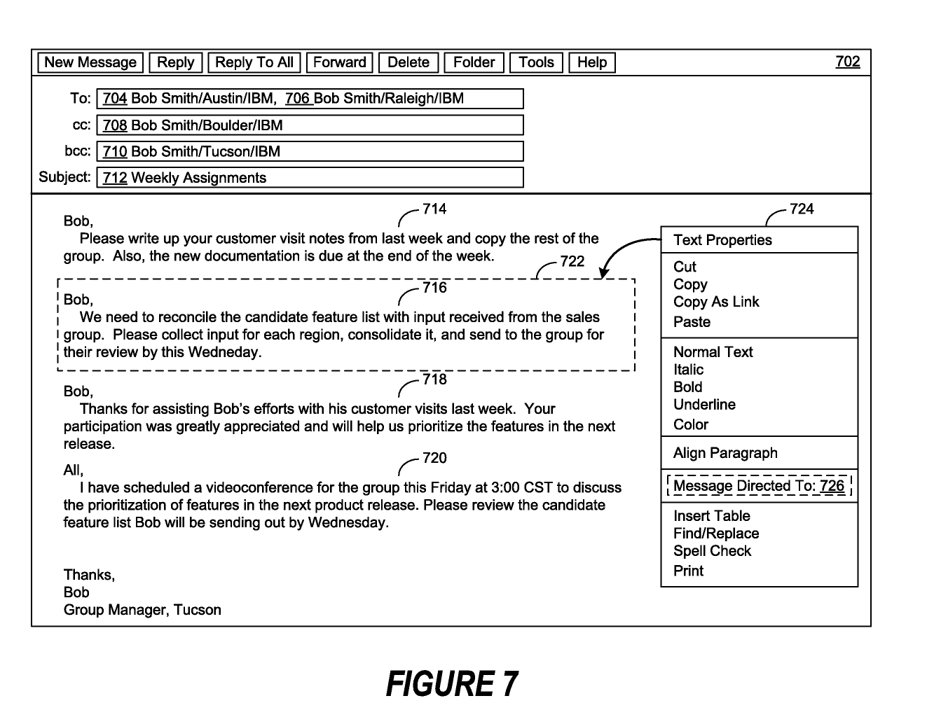

FIG. 7 shows the user interface of an email client used for mapping accentuated subsets of unsent email message content to predetermined recipients. In selected embodiments, an email sender begins composes an email using email client 702. Email ID of predetermined recipients 704, 706, 708, 710, all of which have the same first and last name, are entered into the email client along with the email subject 712.

Composing and addressing an email to multiple recipients that share the same first and last name can create ambiguity and confusion, particularly when the sender has not been diligent in clarifying which content in the email is intended for which recipient. In the course of composing the email, the sender 722 mitigates this issue by accentuating message content 714, 716, 718, 720 that is respectively designated for the previously entered recipients 704, 706, 708, 710. In one embodiment, message content is selected through user gesture, such as using a mouse in a click and drag operation to accentuate the selection 722, which can be displayed as outlined text within the sender's email client interface. In another embodiment, selected text or other content is accentuated in color, with the user having the option to select a different accentuation color for each designated recipient.

The accentuated content is then assigned through similar user gestures to a designated recipient chosen from the previously entered email recipients 704, 706, 708, 710. In one embodiment, a drop-down content attributes window 724 is opened within the email client interface and the sender chooses an assignment option 726. Once chosen, a list of the email recipients previously entered in the “To:” field of the email is presented (not illustrated) and the sender chooses one or more recipients as designees for the accentuated content. The coordinates of the accentuated content and their respective display attributes are then automatically generated and stored in a message recipient mapping table, described in greater detail herein, along with the corresponding email ID of the designated recipient.

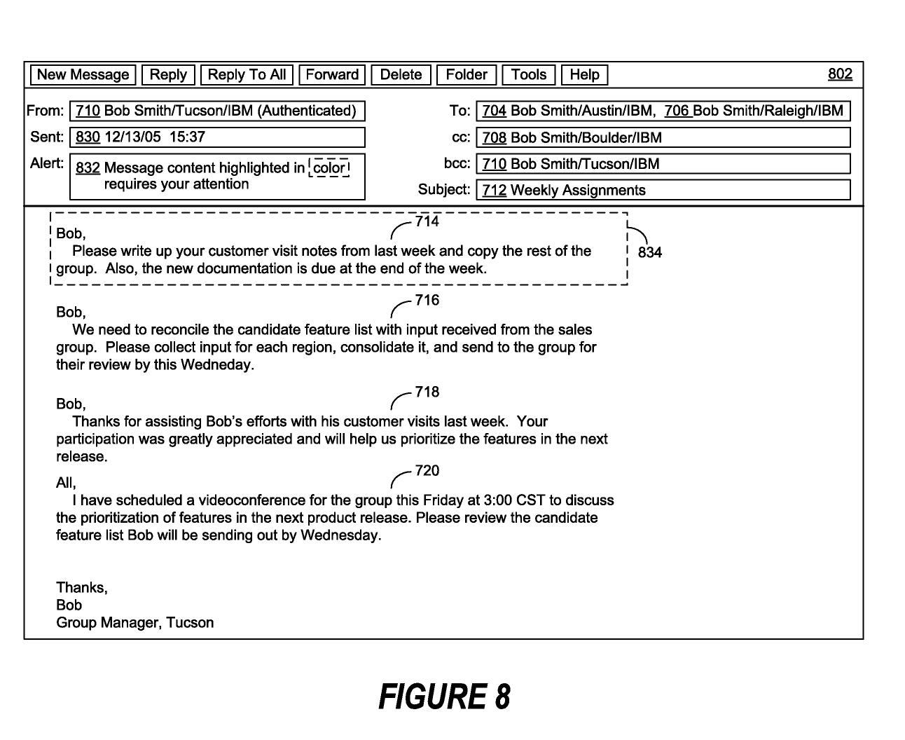

FIG. 8 shows the user interface of an email client used for viewing a subset of received email message content that has been accentuated and mapped to a predetermined recipient. In selected embodiments, recipients 704, 706, 708, 710, all of which have the same first and last name, use email client 702 to receive an email from email sender 830 comprising email subject 712 and date/time stamp 830. The sender 710 has mitigated the ambiguity and confusion of the recipients having the same first and last name by accentuating message content 714, 716, 718, 720 that is respectively designated for the previously entered recipients 704, 706, 708, 710.

In one embodiment, an alert 832 is displayed when a recipient 704 opens the email notifying the recipient that a subset 714 of the email's message content, accentuated in a predetermined color 834, is designated for his attention. In another embodiment, each subset 714, 716, 718, 720 of the email's message content is displayed in a different color, which corresponds to the same text color of the corresponding email recipient 704, 706, 708, 710. In yet another embodiment, selected text or other content is accentuated in color, with the recipient having the option to select a different accentuation color their designated message content. It will be apparent to those of skill in the art that the mapping of accentuated subsets of email message content to a designated recipient mitigates ambiguity and confusion when recipients share similarities in their names. Furthermore, ambiguity and confusion are likewise mitigated when an email contains commingled content intended to be designated for individual recipients, even if they share no name similarities.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for mapping subsets of electronic mail (email) message content sent to a plurality of email recipients having similar names comprising:
creating a list of email identifiers (IDs) for email recipients;
accentuating one or more subsets of email message content to be designated for one or more of the email IDs;
generating identification information identifying accentuated email message content subsets; and,
storing identification information of the accentuated subsets in an associated email recipient mapping table, where the identification information correlates with designated email IDs.

2. The method of claim 1, further comprising:
forwarding email messages comprising accentuated subsets to email recipients; and wherein,
a subset of the email message content corresponds to a designated email recipient being accentuated.

3. The method of claim 1, wherein the identification information comprises coordinates.

4. The method of claim 3, wherein the coordinates comprise a first line number and a first column number identifying a beginning coordinate and a second line number and a second column number identifying an ending coordinate.

5. The method of claim 3, wherein the coordinates comprise a first pixel reference identifying a beginning coordinate and a second pixel reference identifying an ending coordinate.

6. The method of claim 1, wherein the email recipient mapping table comprises display attributes corresponding to the identification information of the accentuated subsets.

7. The method of claim 6 wherein the display attributes result in the accentuated subset being displayed in a predetermined color within an email client of the recipient.

8. The method of claim 6, wherein the display attributes result in the accentuated subset being displayed in a predetermined background color within an email client of the recipient.

9. The method of claim 1, wherein the associated email recipient mapping table is appended to the email message content.

10. The method of claim 1, wherein a message digest of the email message content and the associated email recipient mapping table is generated and then encrypted using a private key of an email sender to generate a digital signature.

11. The method of claim 10, wherein the email message content, the associated email recipient mapping table, the message digest, and a digital signature of the email sender is encrypted by the sender and decrypted by the recipient using public/private key cryptographic operations.

12. A system comprising:
a processor;
a data bus coupled to the processor; and
a computer-usable medium embodying computer program code, the computer-usable medium being coupled to the data bus, the computer program code mapping subsets of electronic mail (email) message content sent to a plurality of email recipients having similar names, the computer program code comprising instructions executable by the processor and configured for:
creating a list of email identifiers (IDs) for email recipients;
accentuating one or more subsets of email message content to be designated for one or more of the email IDs;
generating identification information identifying accentuated email message content subsets; and,
storing identification information of the accentuated subsets in an associated email recipient mapping table, where the identification information correlates with designated email IDs.

13. The system of claim 12, wherein the instructions are further configured for:
forwarding email messages comprising accentuated subsets to email recipients; and wherein,
a subset of the email message content corresponds to a designated email recipient being accentuated.

14. The system of claim 12, wherein the identification information comprises coordinates.

15. The system of claim 14, wherein the coordinates comprise a first line number and a first column number identifying a beginning coordinate and a second line number and a second column number identifying an ending coordinate.

16. The system of claim 14, wherein the coordinates comprise a first pixel reference identifying a beginning coordinate and a second pixel reference identifying an ending coordinate.

17. The system of claim 12, wherein the email recipient mapping table comprises display attributes corresponding to the identification information of the accentuated subsets.

18. The system of claim 17 wherein the display attributes result in the accentuated subset being displayed in a predetermined color within an email client of the recipient.

19. The system of claim 17, wherein the display attributes result in the accentuated subset being displayed in a predetermined background color within an email client of the recipient.

20. The system of claim 12, wherein the associated email recipient mapping table is appended to the email message content.

21. The system of claim 12, wherein a message digest of the email message content and the associated email recipient mapping table is generated and then encrypted using a private key of an email sender to generate a digital signature.

22. The system of claim 21, wherein the email message content, the associated email recipient mapping table, the message digest, and a digital signature of the email sender is encrypted by the sender and decrypted by the recipient using public/private key cryptographic operations.

23. A computer-usable medium embodying computer program code, the computer program code mapping subsets of electronic mail (email) message content sent to a plurality of email recipients having similar names, the computer program code comprising instructions executable by the processor and configured for:
creating a list of email identifiers (IDs) for email recipients;
accentuating one or more subsets of email message content to be designated for one or more of the email IDs;
generating identification information identifying accentuated email message content subsets; and,
storing identification information of the accentuated subsets in an associated email recipient mapping table, where the identification information correlates with designated email IDs.
